(19) United States
(12) Patent Application Publication
(10) Pub. No.: US 2026/0319418 A1
(43) Pub. Date: Oct. 15, 2026

(54) IMAGE FORMING APPARATUS, IMAGE FORMING METHOD, AND NON-TRANSITORY RECORDING MEDIUM

(71) Applicant: Kodai OGAWA, Kanagawa (JP)

(72) Inventor: Kodai OGAWA, Kanagawa (JP)

(73) Assignee: ETRIA CO., LTD., Yokohama (JP)

(21) Appl. No.: 19/466,952

(22) Filed: Feb. 2, 2026

(30) Foreign Application Priority Data
Feb. 17, 2025 (JP) 2025-023436

(51) Int. Cl. G03G 15/00; G03G 15/01; G06K 15/00; G06K 15/02

(52) U.S. Cl. CPC G03G 15/553; G03G 15/0189; G03G 15/5058; G03G 15/80; G06K 15/027; G06K 15/4075; G06K 2215/0094

(57) ABSTRACT

An image forming apparatus includes circuitry to: detect an installation status indicating whether installation of a unit to be used for forming an image is completed; form a pattern image to be used for calculating a remaining life of the unit when the detected installation status indicates that the installation is not completed; receive a determination result based on the formed pattern image; calculate the remaining life of the unit based on the received determination result when the unit is a used unit; and provide a notification of the calculated remaining life of the unit.

### CROSS-REFERENCE TO RELATED APPLICATIONS

This patent application is based on and claims priority pursuant to 35 U.S.C. § 119(a) to Japanese Patent Application No. 2025-023436, filed on Feb. 17, 2025, in the Japan Patent Office, the entire disclosure of which is hereby incorporated by reference herein.

### BACKGROUND

### Technical Field

The present disclosure relates to an image forming apparatus, an image forming method, and a non-transitory recording medium.

### Related Art

For an image forming apparatus of a printing system using an electrophotographic technique, there is known a technique of detecting the life of a unit in the apparatus (arrival of replacement timing) and notifying a user of the life of the unit.

In order to determine or provide a notification of information relating to the life of an image bearer having an uneven surface, an example of an image forming apparatus determines and provides a notification of the life of the image bearer based on a detection result acquired by an optical sensor through irradiation on the surface of the image bearer with light.

### SUMMARY

The present disclosure described herein provides an image forming apparatus including circuitry that detects an installation status indicating whether installation of a unit to be used for forming an image is completed; forms a pattern image to be used for calculating a remaining life of the unit when the detected installation status indicates that the installation is not completed; receives a determination result based on the formed pattern image; calculates the remaining life of the unit based on the received determination result when the unit is a used unit; and provides a notification of the calculated remaining life of the unit.

The present disclosure described herein provides an image forming method performed by an image forming apparatus, the method including detecting an installation status indicating whether installation of a unit to be used for forming an image is completed; forming a pattern image to be used for calculating a remaining life of the unit when the detected installation status indicates that the installation is not completed; receiving a determination result based on the formed pattern image; calculating the remaining life of the unit based on the received determination result when the unit is a used unit; and providing a notification of the calculated remaining life of the unit.

The present disclosure described herein provides a non-transitory recording medium storing a plurality of instructions which, when executed by one or more processors, causes the one or more processors to perform an image forming method including detecting an installation status indicating whether installation of a unit to be used for forming an image is completed; forming a pattern image to be used for calculating a remaining life of the unit when the detected installation status indicates that the installation is not completed; receiving a determination result based on the formed pattern image; calculating the remaining life of the unit based on the received determination result when the unit is a used unit; and providing a notification of the calculated remaining life of the unit.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an example of an image forming apparatus according to a first embodiment;

FIG. 2 is a diagram illustrating an example of a hardware configuration of the image forming apparatus;

FIG. 3 is a diagram illustrating an example of functional blocks of the image forming apparatus;

FIG. 4A is a diagram illustrating an example of a functional block of an installation status detection unit according to the first embodiment;

FIG. 4B is a table presenting an example of data stored in a storage medium included in a unit;

FIG. 5A is a diagram illustrating an example of a toner pattern;

FIG. 5B is a diagram illustrating an example of a pattern image;

FIG. 6 is a view illustrating an example of a density sample;

FIGS. 7A and 7B are graphs each presenting an example of the relationship between the toner adhesion amount of toner adhering to an intermediate transfer belt and the number of printed sheets;

FIGS. 8A and 8B are graphs each presenting an example of the relationship between the actual adhesion amount and the printed image density;

FIG. 9 is a graph presenting an example of calculation of a remaining life by a remaining life calculation unit;

FIG. 10 is a flowchart presenting an example of an installation process of a transfer device according to the first embodiment;

FIG. 11A is a diagram illustrating an example of functional blocks of an installation status detection unit according to a second embodiment; and

FIG. 11B is a table presenting an example of data stored in a storage medium included in a unit.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Referring to the drawings, an image forming apparatus, an image forming method, and a program to execute the method according to exemplary embodiments of the disclosure are described.

### First Embodiment

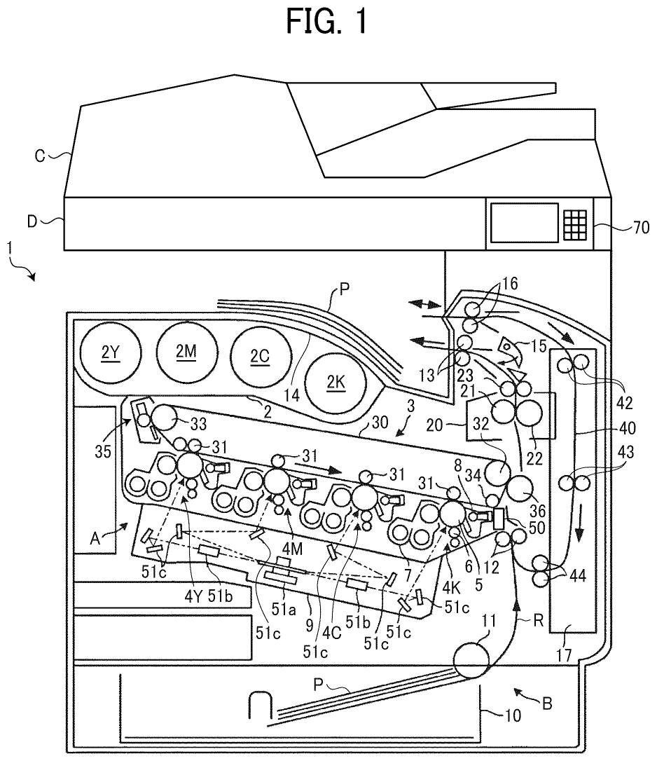

FIG. 1 is a diagram illustrating an example of an image forming apparatus 1 according to a first embodiment. As illustrated in FIG. 1, the image forming apparatus 1 according to the present embodiment includes, for example, an image forming device A, a sheet feeder B, an automatic document feeder (ADF) C, a reader D (flatbed scanner), a fixing device 20, a pair of sheet ejection rollers 13, a sheet ejection tray 14, a pair of reversing rollers 16, and a duplex unit 17.

The image forming device A includes, for example, four image forming units 4Y, 4M, 4C, and 4K, an exposure device 9, and a transfer device 3. These components are examples of units to be used for forming an image.

The image forming apparatus 1 includes the four image forming units 4Y, 4M, 4C, and 4K provided in a center portion of an apparatus body. The image forming units 4Y, 4M, 4C, and 4K have substantially the identical configurations to each other, except for colors of developers (toners). Suffixes, which are Y, M, C, and K, are used to indicate respective colors of developers (e.g., yellow, magenta, cyan, and black toners) for the image forming units 4Y, 4M, 4C, and 4K.

Each of the image forming units 4Y, 4M, 4C, and 4K includes a drum-shaped photoconductor 5 serving as a latent-image bearer, a charging device 6 that charges the surface of the photoconductor 5, a developing device 7 that supplies toner to the surface of the photoconductor 5, and a cleaning device 8 that cleans the surface of the photoconductor 5.

In FIG. 1, the photoconductor 5, the charging device 6, the developing device 7, and the cleaning device 8 included in the black image forming unit 4K are denoted by reference numerals. The other image forming units 4Y, 4M, and 4C have configurations similar to that of the black image forming unit 4K and thus are not denoted by reference numerals.

The image forming apparatus 1 includes the exposure device 9 provided below the image forming units 4Y, 4M, 4C, and 4K. The exposure device 9 exposes the surface of the photoconductor 5 to light. The exposure device 9 includes, for example, a laser light source, a polygon mirror 51a, an f-θ lens 51b, and a plurality of reflecting mirrors 51c, and emits laser light to the surface of each photoconductor 5 based on image data to form an electrostatic latent image on the surface of the photoconductor 5.

The image forming apparatus 1 includes the transfer device 3 provided above the image forming units 4Y, 4M, 4C, and 4K. The transfer device 3 includes an intermediate transfer belt 30 serving as an intermediate transfer body, four primary transfer rollers 31, a secondary transfer roller 36, and a secondary transfer backup roller 32. The transfer device 3 also includes a cleaning backup roller 33, a tension roller 34, and a belt cleaning device 35.

The intermediate transfer belt 30 is an endless belt and is stretched by the secondary transfer backup roller 32, the cleaning backup roller 33, and the tension roller 34. When the secondary transfer backup roller 32 is rotationally driven, the intermediate transfer belt 30 moves to circulate (rotates) in a direction indicated by an arrow in FIG. 1.

Each of the four primary transfer rollers 31 and the corresponding photoconductor 5 nip the intermediate transfer belt 30 to form a primary transfer nip. A power supply is connected to each of the primary transfer rollers 31. A predetermined direct-current (DC) voltage or a predetermined alternating-current (AC) voltage is applied to each of the primary transfer rollers 31.

The secondary transfer roller 36 and the secondary transfer backup roller 32 nip the intermediate transfer belt 30 to form a secondary transfer nip. Similarly to the primary transfer rollers 31, the power supply is also connected to the secondary transfer roller 36, and a predetermined direct-current (DC) voltage or a predetermined alternating-current (AC) voltage is applied to the secondary transfer roller 36.

An optical sensor 50 emits light to the intermediate transfer belt 30 on which a toner pattern (described later) has been formed, and reads the reflected light from the intermediate transfer belt 30 to detect a reflection density of the toner pattern.

The belt cleaning device 35 includes a cleaning brush and a cleaning blade provided in contact with the intermediate transfer belt 30. The waste toner collected by the belt cleaning device 35 is housed in a waste toner container through a waste toner transfer hose.

The image forming apparatus 1 includes a bottle container 2 in an upper portion of the apparatus body. Four toner bottles 2Y, 2M, 2C, and 2K are detachably attached to the bottle container 2. The toner bottles 2Y, 2M, 2C, and 2K house toners for replenishment. The toners are supplied from the toner bottles 2Y, 2M, 2C, and 2K to the corresponding developing devices 7 through replenishment paths provided between the toner bottles 2Y, 2M, 2C, and 2K and the corresponding developing devices 7.

The image forming apparatus 1 includes the sheet feeder B in a lower portion of the apparatus body. The sheet feeder B includes a sheet feeding tray 10 that houses sheets P (recording sheets) serving as sheet media, and a sheet feeding roller 11 that conveys a sheet P from the sheet feeding tray 10.

Examples of the sheet medium include plain paper, thick paper, postcards, envelopes, thin paper, coated paper, art paper, tracing paper, and overhead projector (OHP) transparencies. The image forming apparatus 1 may include a manual sheet feeding mechanism. In the present embodiment, thick paper refers to paper having a basis weight of 160 g/m² or more.

The image forming apparatus 1 includes, in the apparatus body, a conveyance path R through which the sheet P is conveyed from the sheet feeding tray 10, passed through the secondary transfer nip, and ejected to the outside of the apparatus body. The conveyance path R is provided with a pair of registration rollers 12 serving as timing rollers provided upstream of the position of the secondary transfer roller 36 in the conveyance direction of the sheet P. The pair of registration rollers 12 convey the sheet P to the secondary transfer nip at a proper conveyance timing.

The image forming apparatus 1 includes the fixing device 20 provided downstream of the position of the secondary transfer roller 36 in the conveyance direction of the sheet P. The fixing device 20 includes a plurality of rollers 21, and 22, and 23. The fixing device 20 applies pressure and heat to the sheet P bearing an unfixed toner image to fix the toner image to the sheet P.

The image forming apparatus 1 includes the pair of sheet ejection rollers 13 provided downstream of the fixing device 20 in the conveyance direction of the sheet P. The pair of sheet ejection rollers 13 eject the sheet P to the outside of the apparatus body. The image forming apparatus 1 includes the sheet ejection tray 14 provided on an upper surface portion of the apparatus body. The sheet ejection tray 14 stocks sheets P ejected to the outside of the apparatus body.

The image forming apparatus 1 includes a branching member 15 provided between the sheet ejection rollers 13 and the fixing device 20. The branching member 15 is rotatably provided in the apparatus body of the image forming apparatus 1, and is configured to be opened to a first state illustrated in FIG. 1 in a simplex mode in which an image is fixed to just a first side of a sheet P. In a duplex mode in which an image is fixed to a second side of the sheet P having the image fixed to the first side, the branching member 15 is configured to be switched from the first state illustrated in FIG. 1 to a second state in which the branching member 15 is closed in an arrow direction.

That is, the branching member 15 is configured to alternatively guide the sheet P conveyed downstream of the fixing device 20 to one of an external ejection path through which the sheet P is ejected to the sheet ejection tray 14 outside the apparatus body and a reversal path for duplex printing. The external ejection path is a path through which the sheet P passes through the sheet ejection rollers 13. The reversal path is a path (duplex reversal path 40) through which the sheet P passes through the inside of the duplex unit 17 (described later).

The duplex reversal path 40 is provided with the reversing rollers 16 that are provided downstream of the branching member 15 and switch back the sheet P, and the duplex unit 17 that is provided between the reversing rollers 16 and the registration rollers 12. The duplex unit 17 includes conveyance rollers 42 to 44 and forms the reversal path for duplex printing. The sheet P having the image fixed to the first side is switched back by the reversing rollers 16 and conveyed to the registration rollers 12 via the conveyance rollers 42 to 44.

The automatic document feeder C is provided on an upper portion of the reader D and automatically feeds and automatically conveys documents. The documents are conveyed one by one by the automatic document feeder C. When the document passes through the reading position, the reader D exposes the document to light and reads the reflected light from the document. The reader D may read the document by flatbed reading in which the document is read while being fixed.

These reading processes are executed by a scanner engine (described later). The read image data is subjected to processes such as being copied to a sheet P by a printer engine (described later) and being transmitted to an external device via a network interface (I/F) (described later).

A control panel 70 displays, for example, current setting values, selected values, and a mode, and receives an input from the user.

The image forming apparatus 1 receives data of a print job (print job data) from, for example, the reader D, an external digital front end (DFE) device, a personal computer (hereinafter referred to as a “PC”), or a facsimile. The image forming apparatus 1 executes printing (image forming operation) in response to an execution instruction based on the received print job data or an operation performed by the user on the control panel 70 or the like. The print job data includes image data, and job information indicating job attributes such as the number of copies to be printed, the number of pages, the type of sheet, and the type of printing. The type of sheet includes information such as plain paper, gloss paper, mat paper, or embossed paper. The type of printing includes information such as color printing or monochrome printing, and simplex printing or duplex printing. The print job is an example of an image forming job.

The image forming operation of the image forming apparatus 1 according to the embodiment of the present disclosure will be described next.

When the image forming operation is started, the image forming apparatus 1 causes the photoconductor 5 in each of the image forming units 4Y, 4M, 4C, and 4K to be rotationally driven clockwise in FIG. 1, and causes the charging device 6 to uniformly charge the surface of the photoconductor 5 to a predetermined polarity. The exposure device 9 irradiates the charged surface of the photoconductor 5 with laser light, and thus an electrostatic latent image is formed on the surface of the photoconductor 5.

At this time, image information used to expose the surfaces of the photoconductors 5 is monochrome image information produced by decomposing a desired full-color image into yellow, magenta, cyan, and black color information. The electrostatic latent image formed on each photoconductor 5 is developed into a toner image (visible image) with toner supplied by the corresponding developing device 7.

In addition, when the image forming operation is started, the image forming apparatus 1 causes the secondary transfer backup roller 32 to be rotationally driven counterclockwise in FIG. 1, to cause the intermediate transfer belt 30 to rotate and move in a direction indicated by an arrow in FIG. 1.

In the image forming apparatus 1, each primary transfer roller 31 is applied with a voltage having a polarity opposite the charging polarity of the toner, in constant-voltage or constant-current control, so as to generate a transfer electric field in each primary transfer nip between the primary transfer roller 31 and the corresponding photoconductor 5.

Thereafter, when the images of the respective colors on the photoconductors 5 reach the primary transfer nips with the rotation of the photoconductors 5, the image forming apparatus 1 causes the images on the photoconductors 5 to be sequentially transferred onto the intermediate transfer belt 30 in a superimposed manner with the transfer electric fields formed in the primary transfer nips.

In this way, the image forming apparatus 1 causes the surface of the intermediate transfer belt 30 to bear a full-color image. The toner on each photoconductor 5 that has not been transferred to the intermediate transfer belt 30 is removed by the cleaning device 8. The surface of each photoconductor 5 is neutralized by a neutralization device, and the surface potential is initialized.

The image forming apparatus 1 causes the sheet feeding roller 11 to start rotational driving to feed a sheet P from the sheet feeding tray 10 to the conveyance path R. The conveyance of the sheet P sent to the conveyance path R is temporarily stopped by the registration rollers 12.

Thereafter, the image forming apparatus 1 causes the registration rollers 12 to start rotational driving at a predetermined timing to convey the sheet P to the secondary transfer nip in synchronization with the timing at which the images on the intermediate transfer belt 30 reach the secondary transfer nip.

At this time, the secondary transfer roller 36 is applied with a transfer voltage having a polarity opposite the charging polarity of the toners of the images on the intermediate transfer belt 30, so as to generate a transfer electric field in the secondary transfer nip. With the transfer electric field, the images on the intermediate transfer belt 30 are collectively transferred onto the sheet P. At this time, the residual toner on the intermediate transfer belt 30 that has not been transferred to the sheet P is removed by the belt cleaning device 35 and conveyed to the waste toner container.

Thereafter, the sheet P is conveyed to the fixing device 20, and the image on the sheet P is fixed by the fixing device 20. The sheet P conveyed from the fixing device 20 is guided in an ejection direction or a sheet re-feeding direction via the branching member 15 for switching between the path through which the sheet P is ejected to the outside of the apparatus body and the duplex reversal path 40.

In the simplex mode, the branch member 15 is opened to the above-described first state. Accordingly, the sheet P is ejected onto the sheet ejection tray 14 outside the apparatus body of the image forming apparatus 1 by the sheet ejection rollers 13.

In the duplex mode, the branch member 15 is closed to the above-described second state. Accordingly, the sheet P having the image fixed to the first side is guided to the duplex reversal path 40. The sheet P guided to the duplex reversal path 40 is switched back by the pair of reversing rollers 16, conveyed to the duplex unit 17, and conveyed again to the pair of registration rollers 12 to be fed again.

Accordingly, the sheet P is conveyed to the fixing device 20, and the fixing device 20 fixes the image to the second side of the sheet P like the first side. The sheet P is ejected onto the sheet ejection tray 14 outside the apparatus body of the image forming apparatus 1 by the sheet ejection rollers 13.

While the image forming operation when a full-color image is formed on the sheet P has been described above, in one example, a monochrome image may be formed using one of the four image forming units 4Y, 4M, 4C, and 4K. In another example, a two-color or three-color image may be formed using two or three of the four image forming units 4Y, 4M, 4C, and 4K.

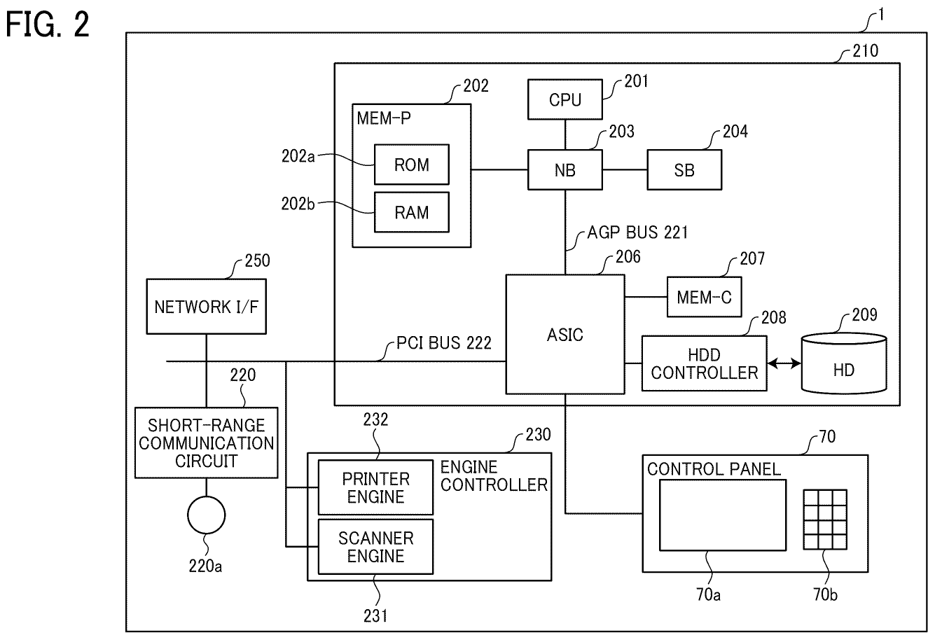

FIG. 2 is a block diagram illustrating an example of a hardware configuration of the image forming apparatus 1.

The image forming apparatus 1 includes a controller 210, a short-range communication circuit 220, an engine controller 230, a control panel 70, and a network I/F 250.

The controller 210 includes a central processing unit (CPU) 201, a system memory (MEM-P) 202, a northbridge (NB) 203, a southbridge (SB) 204, an application-specific integrated circuit (ASIC) 206, a local memory (MEM-C) 207 as a storage area, a hard disk drive (HDD) controller 208, and a hard disk (HD) 209 as a storage area. The storage area may use a solid state drive (SSD).

The NB 203 and the ASIC 206 are connected to each other by an accelerated graphics port (AGP) bus 221.

The CPU 201 is a processor that controls the overall operation of the image forming apparatus 1. The NB 203 is a bridge that connects the CPU 201 to the MEM-P 202, the SB 204, and the AGP bus 221. The NB 203 includes a peripheral component interconnect (PCI) master, an AGP target, and a memory controller that controls the reading or writing of data from or to the MEM-P 202.

The MEM-P 202 includes a read-only memory (ROM) 202a and a random-access memory (RAM) 202b. The ROM 202a is a storage memory for programs and data that implement various functions of the controller 210. The RAM 202b is used for deploying programs and data, as well as for rendering during memory printing. In one example, the program stored in the RAM 202b may be provided by being recorded in a computer-readable recording medium such as a compact disc-read-only memory (CD-ROM), a compact disc-recordable (CD-R), or a digital versatile disk (DVD) in a file of an installable format or an executable format.

The SB 204 is a bridge that connects the NB 203 to a PCI device or a peripheral device. The ASIC 206 is an integrated circuit (IC) dedicated to an image processing use and including hardware elements for image processing, and has a role of a bridge that connects the AGP bus 221, a PCI bus 222, the HDD controller 208, and the MEM-C 207 to one another.

The ASIC 206 includes a PCI target, an AGP master, an arbiter (ARB) as a central processor of the ASIC 206, a memory controller that controls the MEM-C 207, multiple direct memory access controllers (DMACs), and a PCI unit. For example, the DMACs convert the coordinates of image data with a hardware logic to rotate an image based on the image data. The PCI unit transfers data between a scanner engine 231 and a printer engine 232 through the PCI bus 222. The ASIC 206 may be connected to a Universal Serial Bus (USB) interface or the Institute of Electrical and Electronics Engineers (IEEE) 1394 interface.

The MEM-C 207 is a local memory used as a buffer for image data to be copied and a code buffer. The HD 209 is a storage that stores image data, font data for printing, and form data. The HDD controller 208 controls the reading or writing of data from or to the HD 209 under control of the CPU 201.

The AGP bus 221 is a bus interface for a graphics accelerator card that is devised for accelerating processing of graphics. The AGP bus 221 directly accesses the MEM-P 202 with high throughput to accelerate the graphics accelerator card.

The short-range communication circuit 220 is provided with a short-range communication antenna 220a. The short-range communication circuit 220 is a communication circuit in compliance with a standard such as near field communication (NFC) or Bluetooth®.

The engine controller 230 includes the scanner engine 231 and the printer engine 232.

The controller 210 controls the entire image forming apparatus 1 and controls, for example, rendering, communication, input from the control panel 70, the image forming operation, and reading of a document. The scanner engine 231 reads a document and generates image data. The printer engine 232 includes a transfer device, a fixing device, and a heating device or a drying device, and forms (prints) an image on a medium being conveyed, such as a sheet P. The transfer device transfers an image formed with a color material, such as a toner image, onto the sheet P. The fixing device fixes the image to the sheet P. The scanner engine 231 and the printer engine 232 each performs various image processing, such as error diffusion or gamma conversion.

The sheet P is an example of the medium being conveyed. The medium being conveyed is not limited to the sheet of paper. As long as the medium can be placed on the sheet feeding tray 10 included in the image forming apparatus 1, and is conveyed and output in response to an instruction to output the medium, the medium being conveyed may be a sheet of film or a sheet of plastic.

The network I/F 250 is an interface circuit that controls communication of data with various external devices via a communication network. The short-range communication circuit 220 and the network I/F 250 are electrically connected to the ASIC 206 through the PCI bus 222.

The control panel 70 includes a panel display 70a and an operation keypad 70b. The panel display 70a is, for example, a touch panel that displays current setting values, selected values, and a mode, and receives an input from the user. The operation keypad 70b includes, for example, a numeric keypad and a start key. The numeric keypad receives assigned values of image forming parameters such as an image density parameter. The start key receives an instruction to start copying. The control panel 70 receives an input of a determination result based on a pattern image (described later), and displays the calculated remaining life of the transfer device 3. The panel display 70a receives a touch input from the user, and the user can perform operations such as inputting a numerical value to an input box displayed on the screen, selecting an item from a pull-down menu, and turning on/off a check box using a finger, a pen, or the like. The operation keypad 70b may include an input device such as a trackball or a touch pad in addition to the numeric keypad.

While FIGS. 1 and 2 illustrate an example in which the image forming apparatus 1 includes an electrophotographic image forming mechanism, the image forming apparatus 1 according to the present embodiment may include another image forming mechanism of, for example, an inkjet system or a three-dimensional (3D) print system. In this case, for example, a discharge unit that discharges a material to be discharged such as ink is an example of a unit to be used for forming an image. The image forming apparatus 1 is not limited to a multifunction peripheral (MFP), and may be an apparatus such as a copy machine or a facsimile.

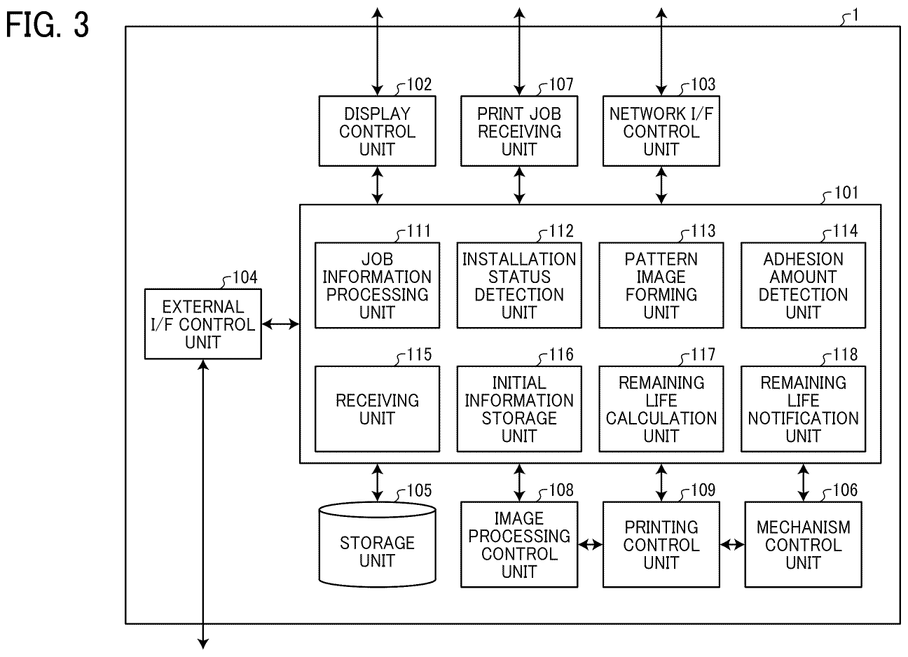

FIG. 3 is a diagram illustrating an example of functional blocks of the image forming apparatus 1. The image forming apparatus 1 includes a system control unit 101, a display control unit 102, a network I/F control unit 103, an external I/F control unit 104, a storage unit 105, a mechanism control unit 106, a print job receiving unit 107, an image processing control unit 108, and a printing control unit 109. Each of these units is implemented when the CPU 201 or the ASIC 206 executes processing defined in a program stored in the MEM-P 202, the MEM-C 207, or the like.

The system control unit 101 controls the entire image forming apparatus 1. The system control unit 101 includes a job information processing unit 111, an installation status detection unit 112, a pattern image forming unit 113, an adhesion amount detection unit 114, a receiving unit 115, an initial information storage unit 116, a remaining life calculation unit 117, and a remaining life notification unit 118.

The job information processing unit 111 extracts job information and image data included in print job data transmitted from the DFE device or the like.

The installation status detection unit 112 detects an installation status indicating whether installation of a unit to be used for forming an image (hereinafter referred to as a “unit”), such as the transfer device 3, is completed. For example, while the image density is adjusted or the remaining life of the unit is set after the unit is replaced, the installation status is “before installation.” The installation status after the work is completed is “installation completed.” With the present embodiment, by detecting the installation status, as will be described later, control is performed such that the installation process is operated and the remaining life is set once during the work performed by a service person or the like. Accordingly, it is possible to prevent an inappropriate remaining life from being set for the unit whose installation is completed.

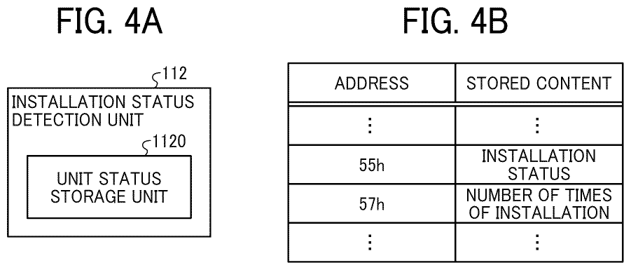

FIG. 4A is a diagram illustrating an example of a functional block of the installation status detection unit 112 according to the first embodiment. FIG. 4B is a table presenting an example of data stored in a storage medium, such as a flash memory included in a unit. As illustrated in FIG. 4A, the installation status detection unit 112 includes a unit status storage unit 1120. The unit status storage unit 1120 stores information on an installation status of a unit and a new/used status indicating whether the unit is a used unit in the storage medium. The used unit refers to, for example, a unit that is not a new product, such as a reused product or a recycled product. A unit that is a new product is referred to as a new unit.

In the example in FIG. 4B, the unit status storage unit 1120 stores data on the installation status in an address 55h of the storage medium, and stores data on the number of times of installation (the number of times a unit has been installed for reuse) in an address 57h of the storage medium. For example, a value 00h of the installation status indicates “installation completed” for the unit. When the value of the installation status is other than 00h, the value indicates “before installation” of the unit.

When the installation of the unit is completed, the unit status storage unit 1120 reads the number of times of installation from the address 57h, adds 1 to the value, and writes the result in the address 57h. The number of times of installation of a new unit is set to 0, and is rewritten to 1 when the first installation is completed. The unit status storage unit 1120 may omit storage of the number of times of installation and store the installation status in the storage medium.

When the installation status detected by the installation status detection unit 112 indicates “before installation,” the pattern image forming unit 113 forms a pattern image to be used for calculating the remaining life. Specifically, the pattern image forming unit 113 reads a pattern image stored in a memory such as the MEM-P 202, and transfers a toner pattern to the intermediate transfer belt 30 and forms (prints) the pattern image on a sheet P using the printer engine 232. The toner pattern is a toner image corresponding to the pattern image.

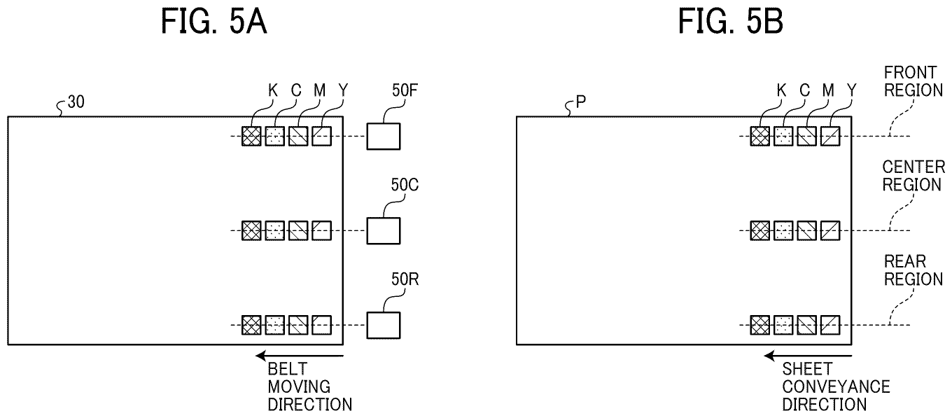

FIG. 5A illustrates an example of a toner pattern formed on the intermediate transfer belt 30. The toner pattern is formed at three positions of front (F), rear (R), and center (C) in a laser scanning direction (hereinafter referred to as a “main scanning direction”) on the photoconductor 5, that is, in end regions and a center region in a direction orthogonal to the moving direction of the intermediate transfer belt 30. In FIG. 5A, a toner pattern is formed in each region. The toner pattern includes color patches of the respective colors of K, C, M, and Y in order from the left.

FIG. 5B illustrates an example of a pattern image formed on a sheet P. The pattern image is formed by transferring the toner pattern on the intermediate transfer belt 30 to a sheet P. As illustrated in FIG. 5B, the pattern image is formed as patterns at three positions of a front region, a center region, and a rear region in the main scanning direction. Each pattern includes color patches of the respective colors of K, C, M, and Y in order from the left.

The adhesion amount detection unit 114 detects the toner adhesion amount of the toner adhering to the toner pattern formed on the intermediate transfer belt 30 using the optical sensor 50. As illustrated in FIG. 5A, the optical sensor 50 includes reflective optical sensors 50F, 50C, and 50R arranged in correspondence with the respective regions where the toner patterns are formed. The optical sensors 50F, 50C, and 50R detect the reflection densities of the toner patterns. Suffixes of respective reference numerals indicate front, center, and rear positions in the main scanning direction. These suffixes are omitted as appropriate. The adhesion amount detection unit 114 acquires the reflection density of each pattern from the output of the optical sensor 50, and detects the toner adhesion amount of the toner adhering to the intermediate transfer belt 30.

The receiving unit 115 receives a determination result based on the pattern image formed by the pattern image forming unit 113. Specifically, the service person or the like inputs an estimated value of the image density determined based on the pattern image and the density sample to the control panel 70 as a determination result. The receiving unit 115 receives the input determination result. The estimated value of the image density is an example of a determination result relating to the density of the pattern image.

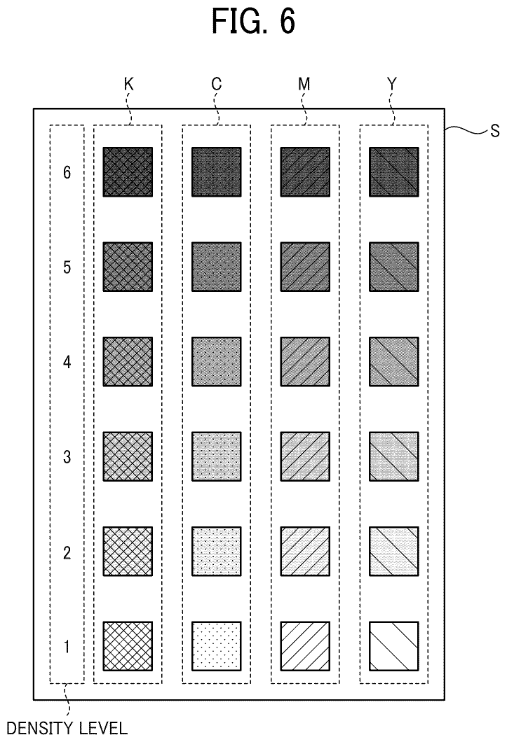

FIG. 6 is a view illustrating an example of a density sample S. The density sample S includes rows of color patches of the respective colors of K, C, M, and Y in order from the left. The color patches in each row have six levels of density in the vertical direction. The density level having a value of 1 represents the lowest density. The density level having a value of 6 represents the highest density. The service person or the like compares the density of the color patch of each color of the pattern image with the density of the density sample S, determines the density of the color, and inputs the result to the control panel 70. The number of density levels is not limited to six, and may be more than or less than six.

For a new unit, the initial information storage unit 116 stores the toner adhesion amount detected by the adhesion amount detection unit 114 and the estimated value of the image density of the pattern image (the determination result received by the receiving unit 115) in a memory such as the MEM-P 202.

For a used unit, the remaining life calculation unit 117 calculates the remaining life of the used unit based on the toner adhesion amount detected by the adhesion amount detection unit 114, the estimated value of the image density of the pattern image, and the data stored by the initial information storage unit 116.

The remaining life notification unit 118 provides a notification of the remaining life of the used unit calculated by the remaining life calculation unit 117. The remaining life notification unit 118 provides the notification of the value of the remaining life by, for example, causing the control panel 70 to display the value, transmitting the value to the service person or the like via an email, or printing the value on a sheet P. The service person or the like can manage the next maintenance timing by, for example, setting the notified remaining life in the memory of the image forming apparatus 1 or storing the notified remaining life in the terminal device of the service person or the like.

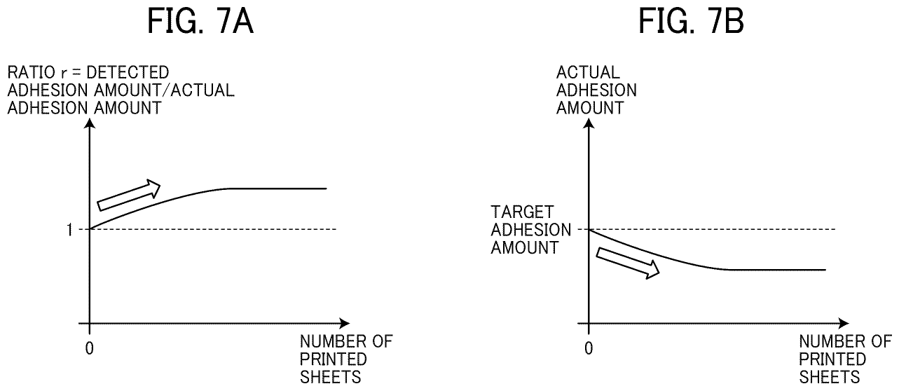

Referring to FIGS. 7A to 9, a method of calculating the remaining life when the transfer device 3 as an example of the unit is a used unit will be described.

FIGS. 7A and 7B are graphs each presenting the relationship between the toner adhesion amount of the toner adhering to the intermediate transfer belt 30 and the number of printed sheets. The vertical axis of the graph in FIG. 7A indicates a ratio r of a toner adhesion amount (detected adhesion amount) detected by the optical sensor 50 to an actual toner adhesion amount (actual adhesion amount), and the horizontal axis of the graph indicates the number of printed sheets. The vertical axis of the graph in FIG. 7B indicates the actual adhesion amount, and the horizontal axis of the graph indicates the number of printed sheets.

A phenomenon called belt filming in which a toner component or a lubricant applied to the photoconductor 5 adheres to the intermediate transfer belt 30 is known. When the belt filming occurs, the optical characteristics of the belt surface change, and hence the optical sensor 50 cannot accurately detect the toner adhesion amount of the toner adhering to the intermediate transfer belt 30. That is, a detection deviation occurs between the actual adhesion amount and the detected adhesion amount.

When the print operation is repeated, the adhering material on the intermediate transfer belt 30 increases, and hence the detection deviation due to the belt filming generally gradually increases as the number of printed sheets increases. It is known that the optical sensor 50 outputs a higher detection result as the detection deviation increases. Thus, as indicated by an arrow illustrated in FIG. 7A, the ratio r increases from an ideal value (1), which has no detection deviation, with an increase in the number of printed sheets.

Since the image forming apparatus 1 performs adjustment based on the detected adhesion amount so that the toner adheres by the target adhesion amount, when the toner adhesion amount is detected to be high, the actual adhesion amount is adjusted to be lower than the target adhesion amount. Thus, as indicated by an arrow illustrated in FIG. 7B, the actual adhesion amount decreases from the target adhesion amount with an increase in the number of printed sheets.

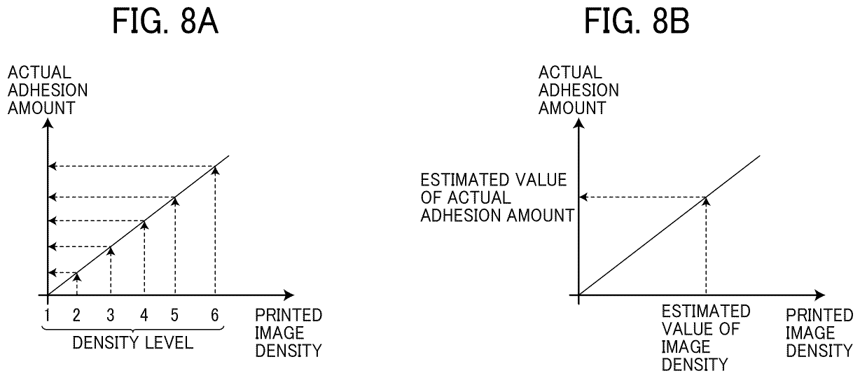

The remaining life calculation unit 117 calculates an estimated value of the actual adhesion amount of the used unit using the correlation between the actual adhesion amount and the printed image density. FIGS. 8A and 8B are graphs each presenting the relationship between the actual adhesion amount and the printed image density. The vertical axis of the graph in each of FIGS. 8A and 8B indicates the actual adhesion amount, and the horizontal axis of the graph indicates the density level. The printed image density is a density to be determined by comparing the density of an image printed on a sheet P at the toner density corresponding to the actual adhesion amount with the density sample S. In the example of FIGS. 8A and 8B, the printed image density is a density determined using the six levels of density illustrated in FIG. 6.

As presented in FIG. 8A, there is the correlation between the actual adhesion amount and the printed image density. For example, when a used unit is installed, the service person or the like visually compares the pattern image printed by the pattern image forming unit 113 with the density sample S to determine the printed image density, and inputs the determination result (the estimated value of the image density) to the control panel 70. As presented in FIG. 8B, the remaining life calculation unit 117 calculates an estimated value of the actual adhesion amount of the used unit from the estimated value of the image density using the correlation between the actual adhesion amount and the printed image density.

The remaining life calculation unit 117 obtains an estimated value of the ratio r from the estimated value of the actual adhesion amount and the detected adhesion amount, and calculates the remaining life using the relationship between the above-described ratio r and the number of printed sheets.

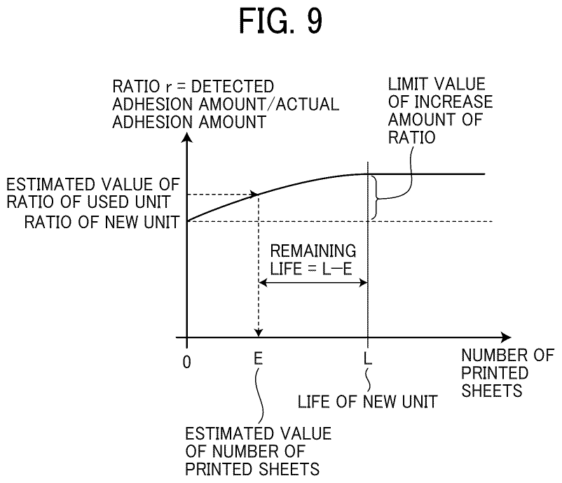

FIG. 9 is a graph presenting an example of calculation of the remaining life by the remaining life calculation unit 117. The graph in FIG. 9 presents the relationship between the ratio r and the number of printed sheets, similarly to the graph in FIG. 7A. For a new unit, it is assumed that the life of the unit is determined as the number of printed sheets=L sheets based on the limit value of the increase amount of the ratio r. The limit value of the increase amount of the ratio r is, for example, a limit value at which the deviation of the printed image density exceeds the allowable range due to the detection deviation between the detected adhesion amount and the actual adhesion amount.

The ratio of the new unit at the initial value (0 sheets) of the number of printed sheets is ideally 1 as presented in FIG. 7A. In the present embodiment, the relationship between the ratio r and the number of printed sheets is obtained using the ratio of the new unit at the initial value, which is calculated from the detected adhesion amount and the actual adhesion amount estimated from the density of the pattern image of the new unit stored in the memory by the initial information storage unit 116. The image forming apparatus 1 may be configured not to include the initial information storage unit 116. In such a case or when the initial information storage unit 116 does not store the data of the new unit in the memory, the ratio of the new unit at the initial value may be set to 1, and the relationship between the ratio r and the number of printed sheets may be obtained.

As presented in FIG. 9, the remaining life of the used unit can be calculated by subtracting the number of printed sheets at the time of installation estimated from the estimated value of the ratio r (an estimated value E of the number of printed sheets) from a life L of the new unit. The remaining life calculation unit 117 calculates the remaining life for each color patch as described above, and calculates the average value of the values calculated for the respective colors as the remaining life. Instead of the average value of the respective colors, the remaining life calculation unit 117 may calculate a minimum value, a maximum value, a median value, or the like of the respective colors as the remaining life.

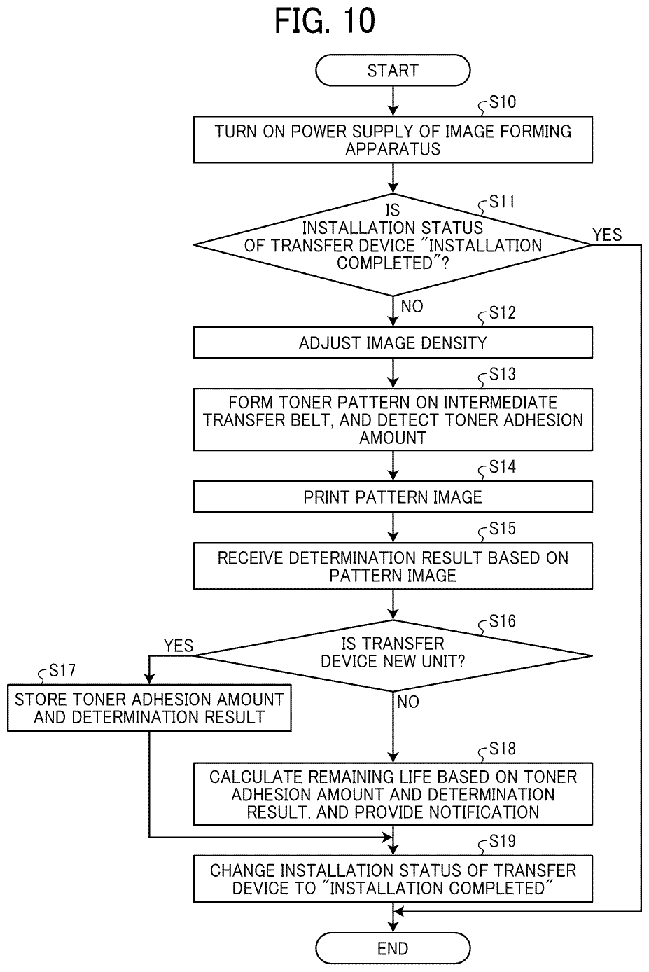

FIG. 10 is a flowchart presenting an example of an installation process of the transfer device 3 according to the first embodiment. The power supply of the image forming apparatus 1 is turned on (step S10), and the installation status detection unit 112 detects the installation status of the transfer device 3. When the installation status of the transfer device 3 is “installation completed” (step S11: Yes), the process ends.

In contrast, when the installation status of the transfer device 3 is not “installation completed” (step S11: No), the process proceeds to an installation flow in step S12 and the subsequent steps. As described above, the installation flow according to the present embodiment is executed when the installation of a unit by the service person or the like is not completed, and is not executed for a unit whose installation is completed.

In step S12, the image forming apparatus 1 adjusts the image density (calibration) (step S12), and sets image forming parameters (for example, a developing voltage, a charging voltage, a writing light intensity, and a toner density). The pattern image forming unit 113 forms a toner pattern as illustrated in FIG. 5A on the intermediate transfer belt 30, and the adhesion amount detection unit 114 detects the toner adhesion amount as the detected adhesion amount (step S13). The pattern image forming unit 113 prints a pattern image as illustrated in FIG. 5B corresponding to the toner pattern (step S14). At this time, the image forming parameters set as described above are used for forming an image.

The receiving unit 115 receives the determination result (the estimated value of the image density) based on the pattern image obtained by the service person or the like (step S15). When the transfer device 3 is a new unit (step S16: Yes), the initial information storage unit 116 stores the toner adhesion amount and the determination result (step S17). In contrast, when the transfer device 3 is not a new unit (step S16: No), the remaining life calculation unit 117 calculates the remaining life based on the toner adhesion amount and the determination result, and the remaining life notification unit 118 provides a notification of the calculated remaining life (step S18).

The unit status storage unit 1120 changes the installation status of the transfer device 3 to “installation completed” (step S19).

As described above, with the present embodiment, when a unit inside an image forming apparatus is replaced with a used unit and the used unit is installed, a notification of the remaining life of the used unit at the time of replacement can be provided.

### Second Embodiment

In a second embodiment, the installation status of a unit is stored using one or more fuses. In the following description of the second embodiment, the description of portions that are the same as those in the first embodiment is omitted, and the differences from the first embodiment are described.

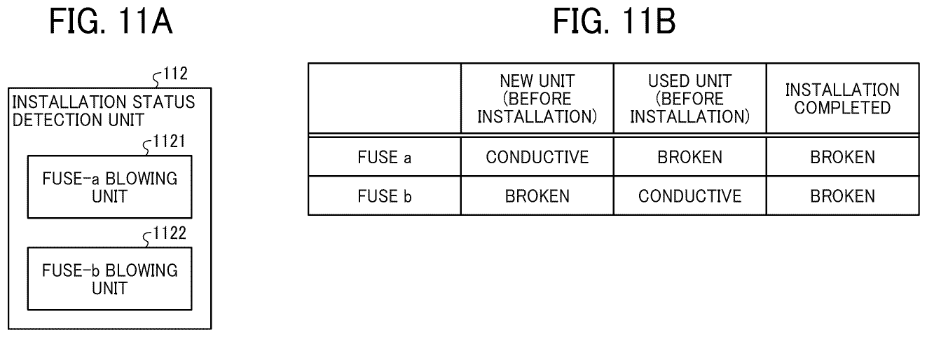

FIG. 11A is a diagram illustrating an example of functional blocks of an installation status detection unit 112 according to the second embodiment. FIG. 11B is a table presenting the relationship between the states of two fuses (a fuse a and a fuse b) included in a unit and the installation status of the unit.

As illustrated in FIG. 11A, the installation status detection unit 112 includes a fuse-a blowing unit 1121 and a fuse-b blowing unit 1122. When the installation of a new unit is completed, the fuse-a blowing unit 1121 blows the fuse a to break the fuse a. When the installation of a used unit is completed, the fuse-b blowing unit 1122 blows the fuse b to break the fuse b.

As presented in FIG. 11B, in the new unit before installation, the fuse a is conductive, and the fuse b is broken. In the used unit before installation, the fuse a is broken, and the fuse b is conductive. In the unit whose installation is completed, both the fuses a and b are broken regardless of whether the unit is a new unit or a used unit. For example, when the unit whose installation is completed is recycled, the fuse b is replaced with a conductive fuse by the service person or the like.

The installation status detection unit 112 detects the installation status of the unit stored based on the conduction states of the two fuses as presented in FIG. 11B. That is, the installation status detection unit 112 can detect whether the installation of the unit is completed and whether the unit before installation is a new unit using the conduction states of the two fuses. The number of fuses included in the unit may be one, and when the fuse is conductive, it may indicate that the installation is not completed, and when the fuse is broken, it may indicate that the installation is completed. The number of fuses included in the unit may be three or more, and the number of times of installation at which the unit is installed for reuse may be further stored.

As described above, with the present embodiment, when a unit inside an image forming apparatus is replaced with a used unit and the used unit is installed, a notification of the remaining life of the used unit at the time of replacement can be provided. In addition, the installation status of the unit can be stored using one or more fuses.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The program to be executed by the image forming apparatus 1 according to each of the embodiments described above is recorded on a computer-readable recording medium such as a compact disc-read-only memory (CD-ROM), a flexible disk (FD), a compact disc-recordable (CD-R), or a digital versatile disk (DVD) in a file of an installable format or an executable format and is provided.

The program to be executed by the image forming apparatus 1 according to each of the embodiments described above may be stored in a computer connected to a network such as the Internet and may be provided by being downloaded via the network. The program to be executed by the image forming apparatus 1 according to each of the embodiments described above may be provided or distributed via a network such as the Internet.

The program according to each of the embodiments described above may be incorporated in a ROM or the like in advance and provided.

The program to be executed by the image forming apparatus 1 according to each of the embodiments described above has a module configuration including the functional units (for example, the job information processing unit 111, the installation status detection unit 112, the pattern image forming unit 113, the adhesion amount detection unit 114, and the receiving unit 115) described above. As actual hardware, a CPU (or processor) reads the program from the above-described recording medium and executes the program such that the above-described functional units are loaded onto a main storage device and implemented on the main storage device.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

For example, aspects of the present disclosure include the following.

According to Aspect 1, an image forming apparatus includes an installation status detection unit that detects an installation status indicating whether installation of a unit to be used for forming an image is completed; a pattern image forming unit that forms a pattern image to be used for calculating a remaining life of the unit when the installation status detected by the installation status detection unit indicates that the installation is not completed; a receiving unit that receives a determination result based on the pattern image formed by the pattern image forming unit; a remaining life calculation unit that calculates the remaining life of the unit based on the determination result received by the receiving unit when the unit is a used unit; and a remaining life notification unit that provides a notification of the remaining life of the unit calculated by the remaining life calculation unit.

According to Aspect 2, the image forming apparatus of Aspect 1 further includes a unit status storage unit that stores the installation status of the unit.

According to Aspect 3, in the image forming apparatus of Aspect 2, the unit status storage unit stores the installation status and a new/used status indicating whether the unit is the used unit in a storage medium included in the unit.

According to Aspect 4, in the image forming apparatus of Aspect 3, the unit status storage unit further stores the number of times the unit has been installed for reuse in the storage medium.

According to Aspect 5, in the image forming apparatus of Aspect 2, the unit status storage unit stores the installation status using a fuse included in the unit.

According to Aspect 6, the image forming apparatus of any one of Aspect 1 to Aspect 5 further includes an adhesion amount detection unit that detects a toner adhesion amount of toner adhering to a toner pattern of the pattern image, the toner pattern being formed on an intermediate transfer belt included in the unit. The determination result includes a determination result relating to a density of the pattern image. The remaining life calculation unit calculates the remaining life of the unit based on the toner adhesion amount detected by the adhesion amount detection unit and the determination result relating to the density of the pattern image.

According to Aspect 7, in the image forming apparatus of Aspect 6, the pattern image forming unit outputs a pattern image including a color patch formed for each of a plurality of colors; and the receiving unit receives a determination result for each of the plurality of colors.

According to Aspect 8, in the image forming apparatus of Aspect 7, the adhesion amount detection unit includes an optical sensor facing the intermediate transfer belt, and the pattern image forming unit detects a toner patch formed on the intermediate transfer belt by the pattern image forming unit to form the color patch.

According to Aspect 9, the image forming apparatus of any one of Aspect 6 to Aspect 8 further includes an initial information storage unit that stores the toner adhesion amount detected by the adhesion amount detection unit and the determination result relating to the density of the pattern image when the unit is not the used unit. The remaining life calculation unit calculates the remaining life of the unit further based on the toner adhesion amount and the determination result stored by the initial information storage unit.

According to Aspect 10, an image forming method executed by an image forming apparatus includes an installation status detection process of detecting an installation status indicating whether installation of a unit to be used for forming an image is completed; a pattern image forming process of forming a pattern image to be used for calculating a remaining life of the unit when the installation status detected in the installation status detection process indicates that the installation is not completed; a receiving process of receiving a determination result based on the pattern image formed in the pattern image forming process; a remaining life calculation process of calculating the remaining life of the unit based on the determination result received in the remaining process when the unit is a used unit; and a remaining life notification process of providing a notification of the remaining life of the unit calculated in the remaining life calculation process.

According to Aspect 11, a program causes a computer to function as means. The means includes installation status detection means for detecting an installation status indicating whether installation of a unit to be used for forming an image is completed; pattern image forming means for forming a pattern image to be used for calculating a remaining life of the unit when the installation status detected by the installation status detection means indicates that the installation is not completed; receiving means for receiving a determination result based on the pattern image formed by the pattern image forming means; remaining life calculation means for calculating the remaining life of the unit based on the determination result received by the receiving means when the unit is a used unit; and remaining life notification means for providing a notification of the remaining life of the unit calculated by the remaining life calculation means.

1. An image forming apparatus comprising circuitry configured to:
detect an installation status indicating whether installation of a unit to be used for forming an image is completed;
form a pattern image to be used for calculating a remaining life of the unit when the detected installation status indicates that the installation is not completed;
receive a determination result based on the formed pattern image;
calculate the remaining life of the unit based on the received determination result when the unit is a used unit; and
provide a notification of the calculated remaining life of the unit.

2. The image forming apparatus according to claim 1, wherein the circuitry is configured to store the installation status of the unit.

3. The image forming apparatus according to claim 2, wherein the circuitry is configured to store the installation status and a new/used status indicating whether the unit is the used unit in a storage medium included in the unit.

4. The image forming apparatus according to claim 3, wherein the circuitry is configured to further store a number of times the unit has been installed for reuse in the storage medium.

5. The image forming apparatus according to claim 2, wherein the circuitry is configured to store the installation status using a fuse included in the unit.

6. The image forming apparatus according to claim 1,
wherein the circuitry is configured to detect a toner adhesion amount of toner adhering to a toner pattern of the pattern image, the toner pattern being formed on an intermediate transfer belt included in the unit,
wherein the determination result includes a determination result relating to a density of the pattern image, and
wherein the circuitry is configured to calculate the remaining life of the unit based on the detected toner adhesion amount and the determination result relating to the density of the pattern image.

7. The image forming apparatus according to claim 6, wherein the circuitry is configured to:
output a pattern image including a color patch formed for each of a plurality of colors; and
receive a determination result for each of the plurality of colors.

8. The image forming apparatus according to claim 7, further comprising an optical sensor facing the intermediate transfer belt,
wherein the circuitry is configured to detect a toner patch formed on the intermediate transfer belt to form the color patch.

9. The image forming apparatus according to claim 6, wherein the circuitry is configured to:
store the detected toner adhesion amount and the determination result relating to the density of the pattern image when the unit is not the used unit; and
calculate the remaining life of the unit further based on the stored toner adhesion amount and the stored determination result.

10. An image forming method performed by an image forming apparatus, the method comprising:
detecting an installation status indicating whether installation of a unit to be used for forming an image is completed;
forming a pattern image to be used for calculating a remaining life of the unit when the detected installation status indicates that the installation is not completed;
receiving a determination result based on the formed pattern image;
calculating the remaining life of the unit based on the received determination result when the unit is a used unit; and
providing a notification of the calculated remaining life of the unit.

11. A non-transitory recording medium storing a plurality of instructions which, when executed by one or more processors, causes the one or more processors to perform an image forming method comprising:
detecting an installation status indicating whether installation of a unit to be used for forming an image is completed;
forming a pattern image to be used for calculating a remaining life of the unit when the detected installation status indicates that the installation is not completed;
receiving a determination result based on the formed pattern image;
calculating the remaining life of the unit based on the received determination result when the unit is a used unit; and
providing a notification of the calculated remaining life of the unit.
